(19) United States
(12) Patent Application Publication
(10) Pub. No.: US 2009/0051193 A1
(43) Pub. Date: Feb. 26, 2009

(54) WINDOW REGULATOR SYSTEM FOR A VEHICLE DOOR ASSEMBLY

(76) Inventors: Everardo A. Hernandez, Shelby Township, MI (US); Santhosh Kumar Karumuri, Inkster, MI (US); M. Guillaume Cuzor, Poilly-Iez-Gien (FR); Stephane Hemond, Ies Bordes (FR)

Correspondence Address: CARLSON, GASKEY & OLDS, P.C., 400 WEST MAPLE ROAD, SUITE 350, BIRMINGHAM, MI, 48009, US

(21) Appl. No.: 12/128,003

(22) Filed: May 28, 2008

Related U.S. Application Data
(60) Provisional application No. 60/957,309, filed on Aug. 22, 2007.

(51) Int. Cl. B62D 25/04; E05F 15/00

(52) U.S. Cl. 296/146.2; 296/146.5; 49/360

(57) ABSTRACT

A window regulator system for a vehicle door module includes at least one guide rib integrally formed with the vehicle door module. A slider is at least partially received on the guide rib.

### BACKGROUND OF THE DISCLOSURE

This disclosure generally relates to a vehicle door assembly, and more particularly to a window regulator system for a vehicle door module.

Vehicle door assemblies for modern automobiles are becoming increasingly complex. A typical vehicle door assembly generally includes a steel framework having an interior cavity for receiving a plastic door module. The plastic door module includes a plurality of attached components including a window glass panel and a window regulator system for supporting and guiding the window glass panel between an open position and a closed position.

Known window regulator systems include an electric motor, guide tracks for guiding the window glass panel, a pulley wire looped about the guide tracks, and two steel guide rail tracks. One guide rail track is positioned adjacent to an A-pillar side of the vehicle, and the other guide rail track is positioned adjacent to a B-pillar side of the vehicle. The window regulator system supports and guides the window glass panel between the open position and the closed position.

Window regulator systems often include a plurality of components that are necessary to accommodate the movement of the window glass panel. These additional components may increase the risk of failure of the window regulator system and increase the installation and repair costs associated with the vehicle door assembly.

### SUMMARY OF THE DISCLOSURE

A window regulator system for a vehicle door module includes at least one guide rib integrally formed with the vehicle door module. A slider is at least partially received on the guide rib.

A vehicle door assembly includes a door frame, a door module attached to the door frame, a window panel supported by the door module and a window regulator system. The window regulator system includes at least one guide rib integrally formed with the door module. A slider is at least partially received on the guide rib and is selectively axially translatable to move the window panel between an open position and a closed position.

A vehicle door assembly includes a door module and a window regulator system supported by the door module. The window regulator system includes a pulley system having a plurality of pulley assemblies. Each of the plurality of pulley assemblies includes a base formed integrally with the door module, a pulley, and a bushing.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a perspective view of an example vehicle door assembly;

FIGS. 2A, 2B and 2C illustrate example door modules of the vehicle door assembly illustrated in FIG. 1;

FIG. 3 illustrates portions of an example window regulator system of the vehicle door assembly illustrated in FIG. 1;

FIG. 4 illustrates another perspective view of the example vehicle door assembly including a steel rail having a run channel;

FIG. 5 illustrates an exploded view of a pulley assembly of the example pulley system of the an example door module; and

FIGS. 6A and 6B illustrate an example pulley assembly before and after a heat staking process.

### DETAILED DESCRIPTION OF THE DISCLOSED EMBODIMENT

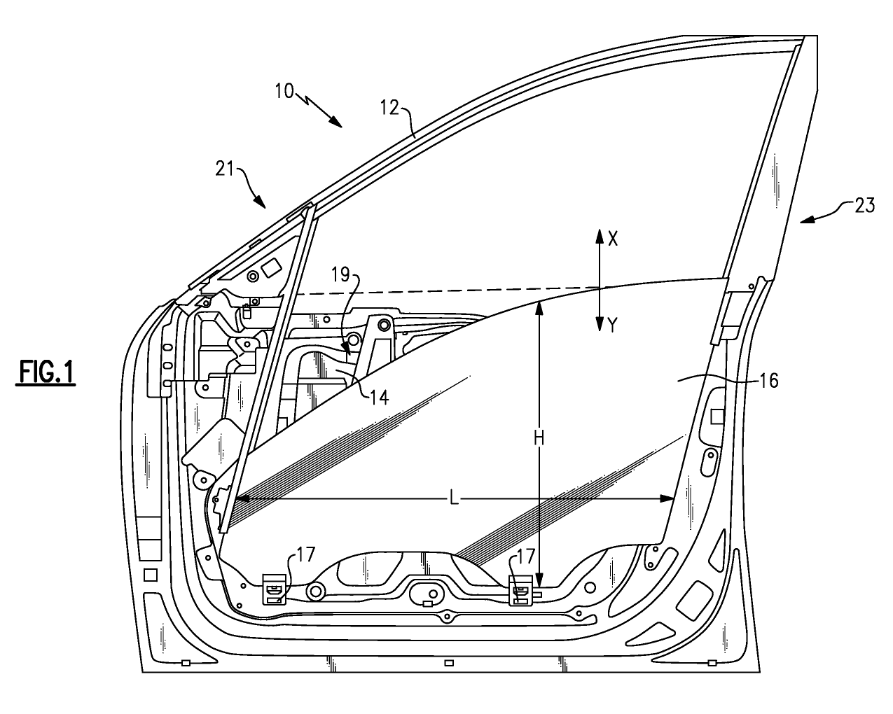

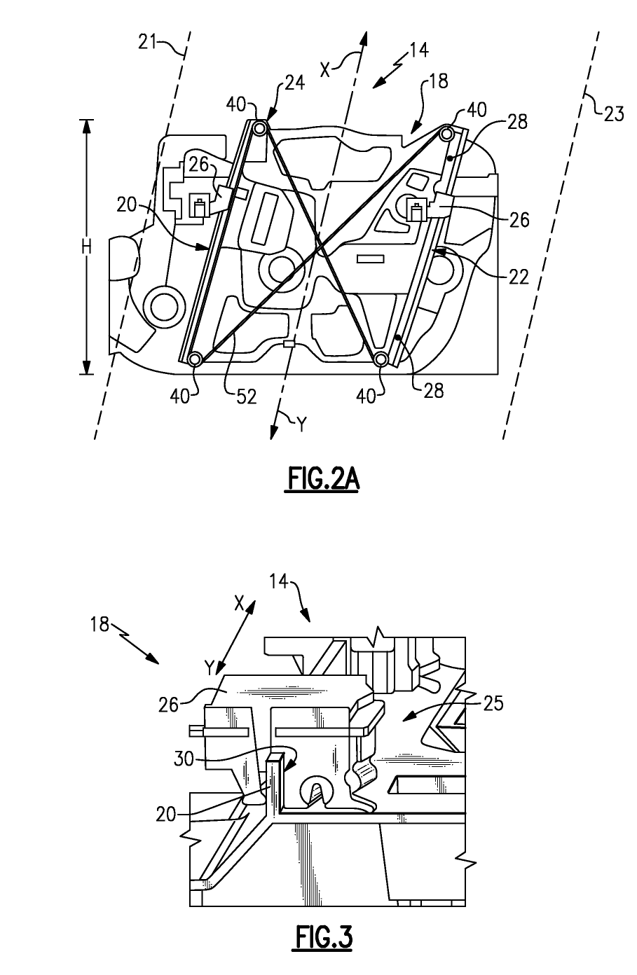

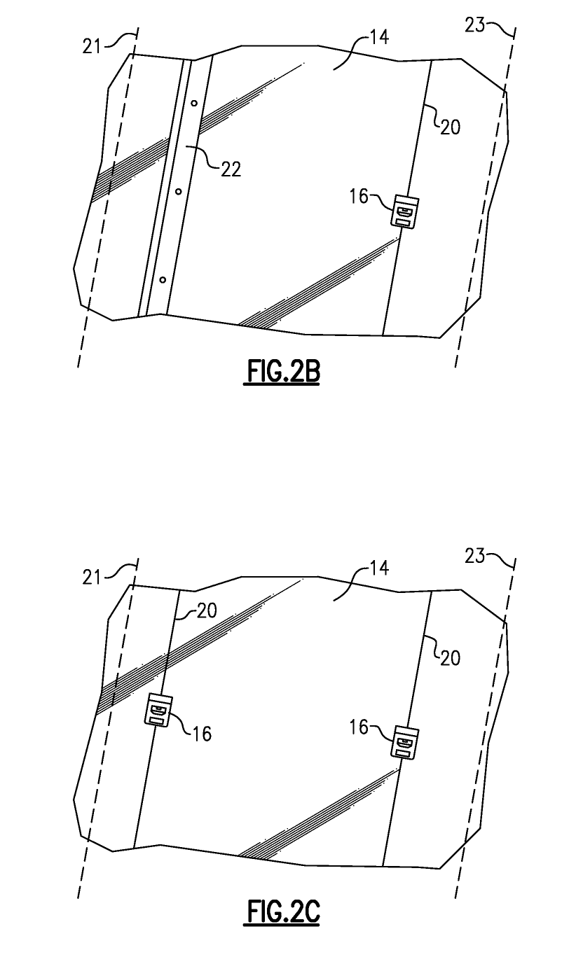

FIG. 1 illustrates an example vehicle door assembly 10 including a door frame 12, a door module 14 attached to the door frame 12, and a window panel 16 translatable between an open position (Y direction) and a closed position (X direction). In one example, the window panel 16 is moved by a window regulator system 18 (see FIG. 2).

In this example, the door frame 12 is steel and the door module 14 is plastic. However, it should be understood that other materials are contemplated as within the scope of this disclosure. That is, a person of ordinary skill in the art would be able to design the vehicle door assembly 10 utilizing any combination of materials.

The door module 14 is attached to the door frame 12 in any known manner. In one example, the door module 14 is received within an interior cavity 19 of the door frame 12. The window panel 16 is partially supported by the example door module 14 with clamps 17, in this example.

FIG. 2A illustrates the door module 14 having an example window regulator system 18 for supporting and guiding (i.e., translating) the window panel 16 between the open and closed positions. The example window regulator system 18 is at least partially supported by the door module 14. That is, the components of the window regulator system 18 are located on and/or mounted to the door module 14.

In this example, the window regulator system 18 includes a guide rib 20, a guide rail 22, a pulley system 24 and sliders 26. The sliders 26 are operable to translate along the guide rib 20 and the guide rail 22 in directions X-Y to move the window panel 16 between the open and closed positions.

In the example illustrated by FIG. 2A, the guide rib 20 is positioned adjacent to an A-pillar side 21 of the vehicle door assembly 10 and the guide rail 22 is positioned adjacent to a B-pillar side 23 of the vehicle door assembly 10. However, an opposite configuration is possible in which the guide rail 22 is positioned adjacent to the A-pillar side 21 of the vehicle door assembly 10 and the guide rib 20 is positioned adjacent to the B-pillar side 23 (See FIG. 2B). In yet another example, a guide rib 20 is provided at both the A-pillar side 21 and the B-pillar side 23, and the guide rail 22 is eliminated from the window regulator system 18 (See FIG. 2C).

The guide rib(s) 20 and the guide rail 22 (if included) extend substantially vertically along an entire height H of the door module 14 to provide guidance for the window panel 16 on each of the A-pillar side 21 and the B-pillar side 23 of the vehicle door assembly 10. In the illustrated example, the guide rib 20 is integrally formed (i.e., molded as a single piece) with the door module 14, while the guide rail 22 is attached to the door module 14 with fasteners 28 as a separate piece. The guide rail 22 is a steel guide rail track, for example.

FIG. 3 illustrates a cross-sectional view of the example guide rib 20 formed onto an exterior surface 25 of the door module 14. The guide rib 20 extends transversely from the exterior surface 25, and is perpendicular to the exterior surface, in one example. That is, the guide rib 20 protrudes from the exterior surface 25 of the door module 14. The actual dimensions of the guide rib 20 will vary depending upon design specific parameters, including but not limited to, the size of the door module 14 and the window panel 16.

A slider 26 is received on the guide rib 20 via a groove 30 formed within the slider 26. The guide rib 20 provides a track for the slider 26 to translate upon to effectuate the movement of the window panel 16 between the open and closed positions. The slider 26 is attached to the clamps 17 (FIG. 1) and is axially moveable along the guide rib 20 in the X-Y directions to translate the window panel 16. Forming the guide rib(s) 20 integrally with the door module 14 allows one or more guide rail(s) to be eliminated from the door module 14. Therefore, the example window regulator system 18 provides a simple and cost effective design.

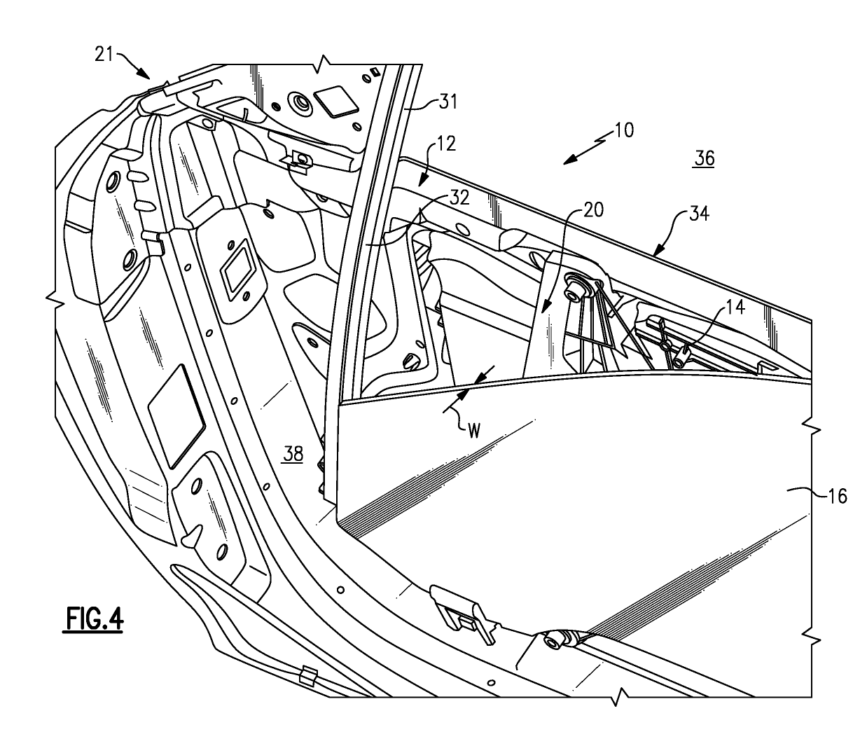

The door module 14 and the window regulator system 18 support the window panel 16 along a length L and a height H of the window panel 16 (See FIG. 1). In addition, as illustrated in FIG. 4, the door frame 12 includes a steel rail 31 positioned adjacent to the A-pillar side 21 of the vehicle door assembly 10. In one example, the steel rail 31 includes a run channel 32 that extends along the steel rail 31 below a belt line 34 of the vehicle door assembly 10. The belt line 34 divides the vehicle door assembly 10 into a window opening portion 36 and a door portion 38.

The run channel 32 receives a portion of the window panel 16. The run channel 32, in conjunction with the door module 14, supports the window panel 16 in a direction of a width W of the window panel 16. Accordingly, the window panel 16 is supported in all directions and remains relatively stable during up and down travel of the window panel 16 and during door slam.

FIG. 5 illustrates an assembly view of an example pulley assembly 40 of the pulley system 24 of the window regulator system 18. In one example, the pulley system 24 includes four plastic pulley assemblies 40 (see FIG. 2). However, a person of ordinary skill in the art having the benefit of this disclosure would understand that the actual number of (and material makeup of) the pulley assemblies 40 included with the pulley system 24 will vary based upon design specific parameters, including but not limited to, the size and shape of the vehicle door assembly 10.

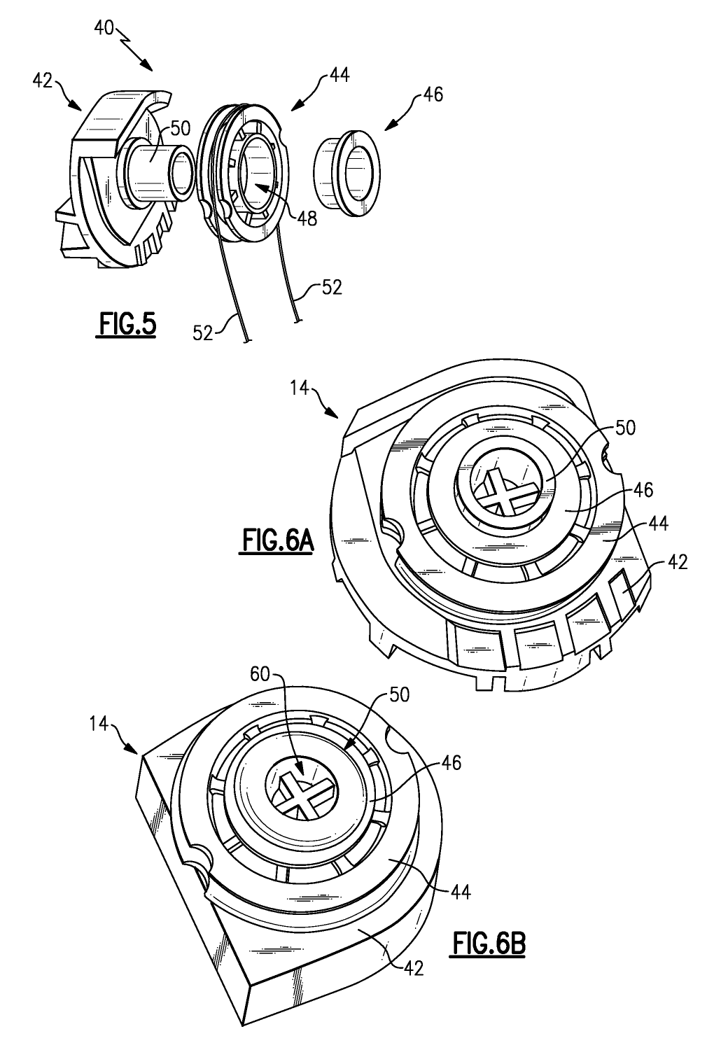

Each pulley assembly 40 of the pulley system 24 is integrated with and positioned on the door module 14. For example, each pulley assembly 40 includes a plastic base 42 formed integrally with the door module 14 (i.e., the plastic base 42 and the door module 14 are molded together as a single piece), a pulley 44 and a bushing 46. The bushing 46 is received within an opening 48 of the pulley 44, and the pulley 44 and the bushing 46 are then received on a post 50 of the plastic base 42 (See FIG. 6A).

In one example, a heat staking process is utilized to attach the pulley 44 and the bushing 46 to the plastic base 42. The post 50 of the plastic base 42 is heated to a melting point and molds around the bushing 46 to permanently assemble the pulley assembly 40 (See FIG. 6B) integrally with the door module 14. In one example, an end 60 of the post 50 flares out and forms around the bushing 46 to permanently mount the pulley assembly 40 components to one another. (See FIG. 6B). The bushing 46 is utilized to reduce wear and assist in the heat staking process. Although described herein as being heat staked, a worker of ordinary skill in the art having the benefit of this disclosure would understand that other processes and methods could be used to integrally form each pulley assembly 40 with the door module 14.

A pulley wire 52 is looped around the numerous pulley assemblies 40 of the pulley system 24. The pulley assemblies 40 route the pulley wire 52 between an electrical motor (not shown) and the sliders 26 for axially translating the window panel 16 (See FIG. 2A).

The foregoing description shall be interpreted as illustrative and not in any limiting sense. A worker of ordinary skill in the art would understand that certain modifications would come within the scope of this disclosure. For these reasons, the following claims should be studied to determine the true scope and content of this disclosure.

What is claimed is:

1. A window regulator system for a vehicle door module, comprising:
at least one guide rib integrally formed with the vehicle door module; and
a slider at least partially received on said guide rib.

2. The system as recited in claim 1, wherein said at least one guide rib is positioned adjacent an A-pillar side of the vehicle door module.

3. The system as recited in claim 1, wherein said at least one guide rib is positioned adjacent a B-pillar side of the vehicle door module.

4. The system as recited in claim 1, wherein said at least one guide rib includes a first guide rib positioned adjacent an A-pillar side of the vehicle door module and a second guide rib positioned adjacent a B-pillar side of the vehicle door module.

5. The system as recited in claim 1, wherein said at least one guide rib extends vertically along a height of the vehicle door module.

6. The system as recited in claim 1, wherein said at least one rib protrudes transversely from an exterior surface of the vehicle door module.

7. The system as recited in claim 1, wherein said slider includes a groove that receives said at least one guide rib, and said slider is axially translatable along said at least one guide rib.

8. The system as recited in claim 1, comprising a guide rail positioned on an opposite side of the vehicle door module from said at least one guide rib.

9. The system as recited in claim 1, wherein the vehicle door module and said at least one guide rib are molded together as a single piece.

10. A vehicle door assembly, comprising:
a door frame;
a door module attached to the door frame;
a window panel supported by said door module; and
a window regulator system that includes at least one guide rib integrally formed with said door module, and a slider at least partially received on said at least one guide rib, wherein said slider is selectively axially translatable along said at least one guide rib to move said window panel between an open position and a closed position.

11. The assembly as recited in claim 10, wherein said door frame includes a rail having a run channel that extends along said rail.

12. The assembly as recited in claim 11, wherein said window panel is at least partially received within said run channel.

13. The assembly as recited in claim 11, wherein said run channel extends along said rail below a belt line of the vehicle door assembly.

14. A vehicle door assembly, comprising:
a door module; and
a window regulator system supported by said door module and including a pulley system having a plurality of pulley assemblies, wherein each of said plurality of pulley assemblies includes a base formed integrally with said door module, a pulley, and a bushing.

15. The vehicle door assembly as recited in claim 14, wherein said base includes a post, and said pulley is received on said post.

16. The assembly as recited in claim 14, wherein said bushing is received within an opening of said pulley.

17. The assembly as recited in claim 14, wherein said pulley and said bushing are heat staked to said base.

18. The assembly as recited in claim 14, comprising at least one guide rib formed integrally with said door module.

19. The assembly as recited in claim 18, wherein said door module and said at least one guide rib are molded together as a single piece.

20. The assembly as recited in claim 18, comprising a slider received on said at least one guide rib, wherein said slider is axially translatable along said at least one guide rib via a pulley wire looped around said plurality of pulley assemblies.
